(19) United States
(12) Patent Application Publication
(10) Pub. No.: US 2018/0238108 A1
(43) Pub. Date: Aug. 23, 2018

(54) Blind Apparatus

(71) Applicant: Louver-Lite Limited, Cheshire (GB)

(72) Inventor: Richard Wileman, Humberside (GB)

(21) Appl. No.: 15/752,516

(22) PCT Filed: Aug. 5, 2016
(86) PCT No.: PCT/GB2016/052453

§ 371 Date: Feb. 13, 2018

(30) Foreign Application Priority Data
Aug. 14, 2015 (GB) 1514502.2

(51) Int. Cl. E06B 9/36; E06B 9/68

(52) U.S. Cl. CPC E06B 9/368; E06B 9/68; E06B 2009/6872; E06B 2009/6827; E06B 2009/6854; E06B 2009/6845

(57) ABSTRACT

A blind apparatus comprising one or more blind substrates; a power source; an electric motor connected to the power source and adapted to move the or each substrate in at least one direction; a resistance sensor; and a controller for controlling the motor, wherein the controller is adapted to increase the power supplied to the motor by the power source when the resistance sensor senses an increased resistance against the movement of the or each blind substrates.

The present invention relates to a blind apparatus and in particular to a blind apparatus including an electric motor for moving a blind substrate.

Window blinds which are operated via electric motors are well known. In such cases, the blind typically includes a controller to control the operation of the motor. Known controllers seek to protect the motor by interrupting the power supply to the motor in the event that the resistance to the motor exceeds a pre-determined threshold. Thus, known controllers may include a torque sensor, and power to the motor may be interrupted when the torque exceeds a specific value.

The problem with such an arrangement is that sometimes the blind apparatus experiences a temporary resistance to its movement. With known controller/motor arrangements, this would cause the motor to stop, which is an inconvenience to the user.

According to a first aspect of the invention, there is provided a blind apparatus comprising a blind substrate; a power source; an electric motor connected to the power source and configured to move the blind substrate in at least one direction; a resistance sensor; and a controller for controlling the motor, wherein the controller is configured to increase the power supplied to the motor by the power source when the resistance sensor senses an increased resistance against the movement of the blind substrate.

It will be appreciated that the blind apparatus of the present invention is able to overcome a temporary resistance to the movement of the blind substrate.

A blind functions to control light, and to some extent heat, entering a room or other architectural space. This can be achieved through the use of a blind substrate comprising a single shading element, for example a sheet-like substrate such as a roller blind, or through the use of a blind substrate comprising a plurality of blind substrate elements, for example multiple parallel blind substrate elements such as a vertical blind or a Venetian blind. In the case of a single blind substrate element, the motor may retract and/or deploy the substrate (i.e. raise or lower the blind substrate). In the case of a blind comprising a plurality of blind substrate elements, the motor may be used to vary the angular orientation of the individual substrate elements and/or the motor may be used to move the substrate elements vertically or horizontally.

The blind apparatus suitably includes a blind substrate comprising a plurality of vertical blind substrate elements, wherein each substrate element is moveable laterally along a track and is rotatable about a respective vertical axis; and wherein the motor is adapted to drive the substrate elements to move laterally and/or to rotate about their respective vertical axis.

The power source may be a mains electrical source or it may be a battery source, wherein the battery or each battery may be rechargeable.

In an embodiment of the invention, the resistance sensor senses the speed of movement of the blind substrate, the blind substrate elements and/or the speed of rotation of the motor, and transmits a signal to the controller when the speed of movement is below a pre-determined threshold speed. When the blind is operating normally, the speed of the motor may be sensed and the controller outputs a first power signal which results in electrical power having a first value being supplied to the motor. If the blind substrate or one of the blind substrate elements encounters an increased resistance to movement, the speed of the motor at the first power setting will decrease. This decrease in speed may be sensed by the resistance sensor and a corresponding signal may be sent to the controller when the rotational speed of the motor decreases below a threshold value or the motor ceases to rotate. The controller may then output a second power signal which results in electrical power having a second value being supplied to the motor, where the second power setting is higher than the first power setting. If the second power setting is not able to overcome the increased resistance within a period of time, power to the motor may be interrupted to protect the motor.

It is desirable for the controller to store information about the end points of the blind movement (e.g. translational position or rotational position) and also to store positional information about the blind when it is between its end points. In view of this, the blind apparatus may further include a positional sensor adapted to sense the position of the blind substrate or each blind substrate element.

In an embodiment of the invention, the positional sensor includes a disc including an array of circumaxial apertures. In other words, the disc includes a circular array of apertures which are equally spaced from the centre of the disc. Such a positional sensor disc may be referred to as an encoder wheel. Suitably, such a positional sensor disc is located for rotation relative to a light sensor suitably comprising a light emitter and corresponding light receiver. The positional sensor disc may rotate with the rotation of the motor and the light sensor is able to translate the rotation of the motor into a digital (i.e. binary) signal on the basis of light being received by the receiver when it passes through one of the circumaxial apertures (a first value) or light not being received by the receiver when the body of the disc blocks the light transmission (a second value). The light sensor may sense the time interval between adjacent apertures being aligned with the light sensor and the speed of rotation of the encoder wheel may be calculated from the sensed time interval. The skilled person will appreciate that reference herein to the speed of rotation of the encoder wheel includes the measurement of a time interval between successive events related to the rotation of the motor, wherein the actual speed of rotation is not actually measured or calculated.

The apertures may be equally spaced from each other. In other words, the apertures may be equally circumaxially spaced. The controller may be able to determine both positional information and rotational speed information from the positional sensor disc. Thus, the resistance sensor may include the positional sensor. Furthermore, the resistance sensor may sense the rotational speed of the positional sensor.

In order that the controller is able to generate output responses based on input signals, the controller suitably includes a programmable processor which is able to execute programmed instructions. Furthermore, in order that the controller is able to store pre-programmed instructions and is able to store information relating to the end points of movement of the blind substrate and data relating to the position of the blind substrate or each substrate element in use, the controller may further include a memory adapted to store data in a retrievable form.

Electrically operated blinds are typically controlled by a remote user input device which may be electrically connected to the controller by wires or cables, or may be wirelessly connected to the controller. In the case that the remote user input device is wirelessly connected to the controller, the controller may include a wireless signal receiver adapted to receive control signals from the user input device. Furthermore, the remote user input device may include a wireless signal transmitter.

In addition to user inputs, the controller may receive inputs from remote sensors, such as a temperature sensor, a light sensor and/or a time sensor (e.g. a clock). Thus, the controller may respond to a temperature increase within a room or other architectural space by fully or partially closing the blind substrate(s) and to a decrease in temperature by fully or partially opening the blind substrate(s). Furthermore, the controller may respond to an increase in the sensed light intensity within a room or other architectural space by fully or partially closing the blind substrate(s) and to a decrease in the sensed light intensity by fully or partially opening the blind substrate(s). Additionally, the controller may move the blind substrate(s) at certain pre-determined times during the day. Thus, the controller may receive inputs from a time sensor or it may include a time sensor.

In this way, the blind substrate(s) may be moved automatically in response to changing environmental conditions within the room or other architectural space or at pre-programmed times.

In view of the above, the apparatus may further include one or more remote sensors, optionally selected from a temperature sensor, a light sensor (such as a light intensity sensor) and a time sensor (e.g. a clock).

The further remote sensors may have a wired connection to the controller or they may be connected to the controller wirelessly. In the embodiments in which the remote sensors are connected to the controller wirelessly, the wireless signal may be transmitted via a radio frequency signal, in which case the or each remote sensor may include an RF transmitter and the apparatus may include an RF receiver; or the wireless signal may be transmitted over a wireless data network, in which case the or each remote sensor and the controller may be connected to a wireless local area network (LAN), a wide area network (WAN) or the internet.

In a further embodiment, the apparatus may include a remote communications hub, wherein the hub includes a data receiver connected to a network and a data transmitter adapted to transmit data to a receiver connected to the controller. In such an embodiment, the hub may be connected to a LAN, WAN or the internet to receive remote signals from remote controllers or sensors. The hub may also include an RF transmitter which is adapted to communicate with an RF receiver connected to the controller. It will be appreciated that RF receivers are relatively small and cheap components that can be connected to the controller. However, RF transmitters have a fairly limited range. Accordingly, the use of a communications hub allows for signals to be received across a network, without the controller itself being connected to the network.

According to a second aspect of the invention, there is provided a vertical blind including a blind apparatus as defined anywhere hereinabove, wherein the blind substrate comprises a plurality of vertical blind elements each carried by a respective carrier truck.

In an embodiment of the second aspect of the invention, the motor may cause the horizontal translational movement of the carrier trucks along a respective track and/or it may cause the rotation of each vertical louver about its respective vertical axis. Suitably, the motor causes each vertical louver to rotate about its respective vertical axis.

In a further embodiment of the invention, the blind apparatus of the second aspect of the invention is adapted to rotate each vertical louver about its respective vertical axis and the vertical blind further includes a second motor adapted to move translationally the carrier trucks along a track. In this embodiment, the second motor may be as described herein and may include a resistance sensor and a controller as described hereinabove. The second motor may be connected to the same power source as the first motor or it may be connected to a second, separate power source.

The blind apparatus of the second aspect of the invention may further include one or more remote sensors, a remote user input device and/or a communications hub as described above in connection with the first aspect of the invention.

Blind components are typically sold by the manufacturers to blind installers, who then take the components to build and install bespoke blinds for the end user. Thus, according to a third aspect of the invention, there is provided a kit of parts comprising a blind substrate or a plurality of blind substrate elements; a power source; an electric motor adapted for connection to the power source and adapted for connection to the substrate or each substrate element, wherein the motor is capable of moving the blind substrate or each blind substrate element in at least one direction; a resistance sensor; and a controller for controlling the motor, wherein the controller is adapted to increase the power supplied to the motor by the power source when the resistance sensor senses an increased resistance against the movement of the blind substrate or any of the blind substrate elements.

The kit may further include a positional sensor as described and defined hereinabove. Furthermore, the controller of the third aspect of the invention may be as described and defined hereinabove. Thus, the controller may comprise a processor, a memory and/or a signal receiver.

Additionally, the kit of the third aspect of the invention may further include one or more remote sensors, a remote user input device and/or a communications hub as described above in connection with the first aspect of the invention.

In an embodiment of the third aspect of the invention, the blind substrate comprises a plurality of vertical louvers wherein each vertical louver is suspended from a respective carrier truck and is rotatable about a vertical axis. Suitably, the carrier trucks are moveable along a substantially horizontal track. Thus, the carrier trucks are adapted for translational movement.

In embodiments of the third aspect of the invention, the blind substrate may comprise a plurality of blind substrate elements (such as vertical or horizontal louvers) and the kit may further include a second motor and a second controller, wherein the first electric motor is adapted to cause rotation of each of the blind substrate elements and the second motor is adapted to cause translational movement of each of the blind substrate elements.

The skilled person will appreciate that the features described and defined in connection with the aspect of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings in which:

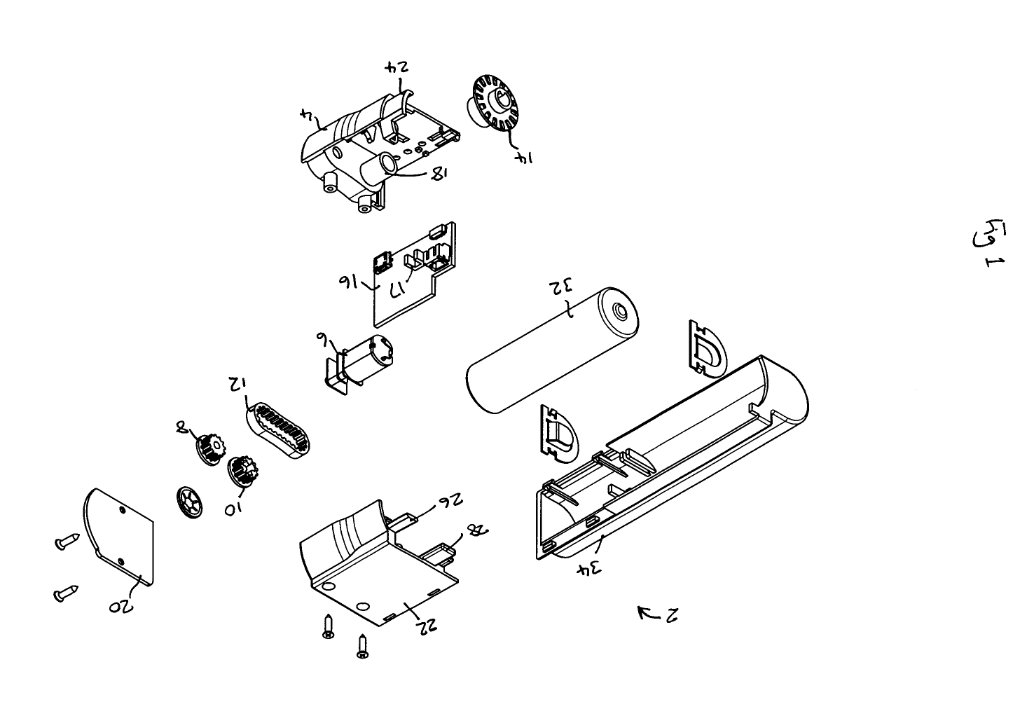

FIG. 1 is an exploded perspective view of the control end assembly of a blind apparatus according to the first aspect of the invention;

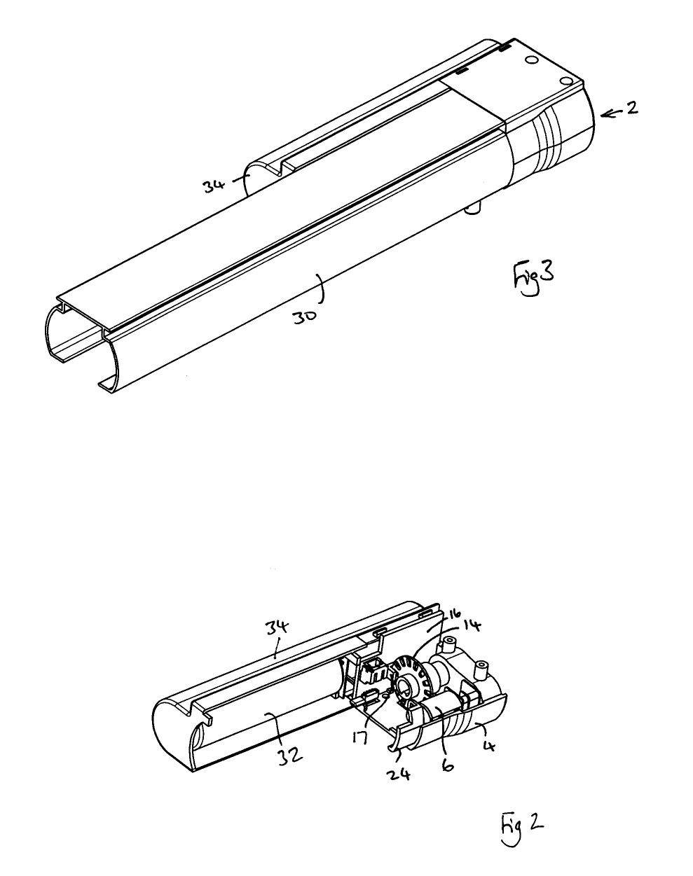

FIG. 2 is a perspective view of the control end assembly of FIG. 1 in an assembled state;

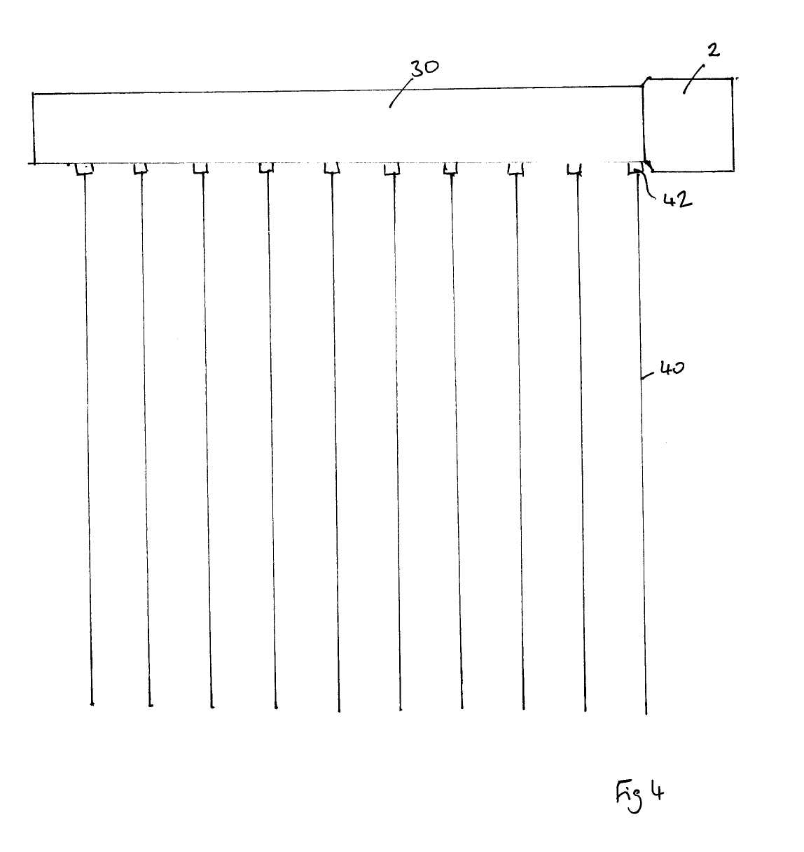

FIG. 3 is a perspective view showing the mounting of the control end assembly to one end of a headrail; and

FIG. 4 is a front elevational view of a vertical louver blind including the control end assembly shown in FIG. 1.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIG. 1 shows a blind apparatus control end assembly 2 in an exploded state. The assembly comprises a drive housing 4 which retains therein an electric motor 6, a drive gear wheel 8, a tilt rod gear wheel 10, a toothed drive belt 12, an encoder wheel 14 and a printed circuit board (PCB) 16.

The drive gear wheel 8 is secured to the drive shaft of the motor 6 and is driven to rotate by the motor 6. The drive gear wheel 8 in turn is coupled to the tilt rod gear wheel 10 by the toothed drive belt 12 such that the rotation of the drive gear wheel 8 drives the tilt rod gear wheel 10 to rotate.

The tilt rod gear wheel 10 defines an open end comprising a cylindrical channel having three circumferentially spaced inwardly projecting ribs. A conventional tilt rod (not shown) has one end engaged within the cylindrical channel defined by the open end of the tilt rod gear wheel 10 and the inwardly projecting ribs engage corresponding axial channels defined by the tilt rod such that the tilt rod is rotationally locked relative to the tilt rod gear wheel 10.

The tilt rod passes through a guide channel 18 which defines a bearing surface for the encoder wheel 14 such that the encoder wheel 14 rotates about the outer surface of the guide channel 18. The encoder wheel 14 includes an internal channel sized to receive therein the tilt rod and the internal channel of the encoder wheel 14 includes an inwardly facing rib which engages one of the three axial channels of the tilt rod such that the encoder wheel 14 is rotationally locked to the tilt rod. According to this arrangement, rotation of the tilt rod gear wheel 10 by the drive gear wheel 8 causes the tilt rod to rotate. The rotation of the tilt rod causes a consequential rotation of the encoder wheel 14.

The encoder wheel 14 includes an array of equally spaced circumaxial apertures which provides an alternating arrangement of apertures and solid material. An edge portion of the encoder wheel is located between a light sensor 17 comprising a light emitter and a light receiver, which is carried by the PCB 16. As the encoder wheel rotates, light is either received by the light receiver (when an aperture is aligned with the light beam) or is blocked from the receiver (when the solid material of the encoder wheel is aligned with the light beam). This arrangement converts the rotation of the encoder wheel 14 into a binary data stream which is detected by the light sensor 17 and transmitted to a processor (not shown) forming part of the PCB 16. The data stream allows the processor to detect the speed of rotation of the encoder wheel 14 (and therefore also the speed of rotation of the tilt rod) by measuring the time taken for adjacent apertures to pass through the light sensor. It also allows the processor to calculate the angular position of the vertical louvers which are rotated by the tilt rod and the end points between which the louvers are able to rotate. For example, the louvers may rotate between an aperture count of 0 and 158, wherein at positions 0 and 158, the louvers are substantially parallel to a window (i.e. the blind is in a fully closed configuration) and at position 79, the louvers are substantially perpendicular to the window (i.e. the blind is in an open configuration). With the end points and the current angular orientation of the louvers known, the louvers can be rotated to any desired orientation.

The drive housing 4 is closed at one end with an end cap 20 and from above by a top cover 22.

The drive housing 4 further includes a forward extending locating lug 24 and the top cover 22 further includes similar forward extending locating lugs 26, 28. The locating lugs 24, 26, 28 assist with locating the assembled control assembly 2 in one end of a vertical blind headrail 30 (shown in FIG. 3).

The control assembly further includes a power source in the form of a rechargeable battery 32 which is located within a battery housing 34, which when assembled is secured to the drive housing 4 and the top cover 22.

Turning to FIG. 3, a vertical louver headrail 30 is shown with the control end assembly 2 located at one end thereof. The headrail 30 has translationally mounted therein a number of carrier trucks in use, wherein each carrier truck has suspended therefrom a vertical louver. A louver hanger of each carrier truck allows its respective louver to rotate between approximately 180° and each louver hanger is driven to rotate by the tilt rod.

FIG. 4 shows an arrangement of a vertical blind in accordance with the second aspect of the invention. The vertical blind comprises the control end assembly 2 secured to the headrail 30. Located within the headrail 30 are a number of carrier trucks (not shown), each of which includes carries a respective vertical louver 40 depending from a louver hanger 42. Each louver hanger 42 is arranged to rotate about a vertical axis when the tilt rod rotates about its horizontal rotational axis, such that rotation of the tilt rod results in the rotation of each vertical louver 40.

The arrangement and operation of vertical blinds generally is described in more detail in GB2031493, GB2335222 and GB2369392, the contents of which are incorporated herein by reference. In particular, these documents describe examples of carrier trucks, louver hangers and tilt rods.

In use, a user inputs a command on a remote control device (not shown) to rotate the louvers of the blind. A wireless signal receiving which forms a component on the PCB 16 receives the signal and a processor carried by the PCB 16 converts the instruction to a first output signal wherein the PCB supplies a first voltage and current to the motor. If no excessive resistance is experienced, the motor will rotate the tilt rod as described above and the encoder wheel 14 will rotate through the light beam as the tilt rod rotates. The rotation of the encoder wheel causes the transmission of the light beam to the receiver to be intermittently interrupted and the speed of the interruptions is measured by the light receiver. The time interval between adjacent apertures of the encoder wheel 14 is suitably between 100 and 400 milliseconds in normal use. Each light transmission is counted as a single unit and the encoder wheel may rotate between end points of 0 and 158 as the louvers rotate between the end points of their rotational movement.

If the rotational speed of the encoder wheel 14 drops below a pre-determined threshold speed or the rotation of the encoder wheel 14 stalls (i.e. the time interval between adjacent apertures passing through the light sensor exceeds a pre-determined value, for example 400 or 500 milliseconds), a signal is sent to the processor. Upon receipt of the signal indicating that an unexpected resistance has been encountered, the processor generates a second output signal wherein an increased voltage and/or current is supplied to the motor, thereby increasing the speed of the motor.

On the basis that the increased resistance was a temporary phenomenon, the encoder wheel will increase in its rotational speed and the increase in speed will be detected (again via the time interval between adjacent apertures passing through the light sensor). If the rotational speed exceeds a pre-determined threshold (i.e. the time interval decreases below a second threshold value), the processor will generate a first output signal which will decrease the power supplied to the motor back to the first power setting. Alternatively, if the increased power supplied to the motor is unable to overcome the resistance, the processor will interrupt the power supply to the motor to prevent damage to the motor.

1. A blind apparatus comprising a blind substrate; a power source; an electric motor connected to the power source and adapted to move the blind substrate in at least one direction; a resistance sensor; and a controller for controlling the motor, wherein the controller is adapted to increase the power supplied to the motor by the power source when the resistance sensor senses an increased resistance against the movement of the blind substrate.

2. A blind apparatus according to claim 1, wherein the blind apparatus includes a plurality of vertical blind substrate elements, wherein each substrate element is moveable laterally along a track and is rotatable about a respective vertical axis; and wherein the motor is adapted to drive the substrate elements to move laterally and/or to rotate about their respective vertical axis.

3. A blind apparatus according to claim 1, wherein the resistance sensor senses the speed of movement of the blind substrate or each blind substrate element and transmits a signal to the controller when the speed of movement is below a pre-determined threshold speed.

4. A blind apparatus according to claim 1, wherein the controller controls the power supplied to the motor such that it is at a first power level when the sensed resistance is below a pre-determined value; and is at a second power level when the sensed resistance is above the predetermined value, wherein the second power level is greater than the first power level.

5. A blind apparatus according to claim 4, wherein the controller is adapted to interrupt the power supply to the motor if the resistance remains above the predetermined value for a period of time at the second power level.

6. A blind apparatus according to claim 1 5, wherein the apparatus further includes a positional sensor adapted to sense the position of the blind substrate or each blind substrate element.

7. A blind apparatus according to claim 6, wherein the positional sensor includes a disc including an array of circumaxial apertures.

8. A blind apparatus according to claim 7, wherein the resistance sensor includes the positional sensor and the resistance sensor senses the rotational speed of the positional sensor.

9. A blind apparatus according to claim 1, wherein the controller includes a signal receiver adapted to receive control signals from a user input device.

10. A blind apparatus according to claim 9, wherein the signal receiver is a wireless signal receiver and the user input device includes a wireless signal transmitter.

11. A blind apparatus according to claim 1, wherein the controller includes a programmable processor.

12. A blind apparatus according to claim 1, wherein the controller includes a memory.

13. A vertical blind including a blind apparatus according to claim 1, wherein the blind substrate comprises a plurality of vertical blind substrate elements each carried by a respective carrier truck.

14. A vertical blind according to claim 13, wherein the motor controls the rotation of the vertical blind substrate elements about their respective vertical axes.

15. A kit of parts comprising a blind substrate or a plurality of blind substrate elements; a power source; an electric motor adapted for connection to the power source and adapted for connection to the substrate or each substrate element, wherein the motor is capable of moving the blind substrate or each blind substrate element in at least one direction; a resistance sensor; and a controller for controlling the motor, wherein the controller is adapted to increase the power supplied to the motor by the power source when the resistance sensor senses an increased resistance against the movement of the blind substrate or any of the blind substrate elements.

16. A kit of parts according to claim 15, wherein the blind substrate comprises a plurality of vertical louvers wherein each vertical louver is suspended from a respective carrier truck and is rotatable about a vertical axis.
